(19) United States
(12) Patent Application Publication
(10) Pub. No.: US 2010/0118148 A1
(43) Pub. Date: May 13, 2010

(54) Illumination Apparatus

(76) Inventor: Young Hwan Lee, Seoul (KR)

Correspondence Address: THE LAW OFFICES OF ANDREW D. FORTNEY, PH.D., P.C., 215 W FALLBROOK AVE SUITE 203, FRESNO, CA, 93711, US

(21) Appl. No.: 12/615,148

(22) Filed: Nov. 9, 2009

Related U.S. Application Data
(60) Provisional application No. 61/113,529, filed on Nov. 11, 2008.
(60) Provisional application No. 61/113,531, filed on Nov. 11, 2008.

(30) Foreign Application Priority Data
Nov. 11, 2008 (KR) 10-2008-0111907
Nov. 11, 2008 (KR) 10-2008-0111909
Jan. 9, 2009 (KR) 10-2009-0001713

(51) Int. Cl. H04N 5/33; H05B 37/02; H01J 1/62; H04N 5/232; G08B 17/00

(52) U.S. Cl. 348/164; 315/294; 313/504; 315/149; 348/211.99; 340/584; 348/E05.09; 348/E05.042

(57) ABSTRACT

An illumination apparatus is provided, including an adapter that converts alternating power into driving power; a communication unit connected to the adapter and configured to communicate with a remote controller; a controller connected to the communication unit and configured to generate a control signal according to a control command from the communication unit; and a light emitting device illumination part configured to be connected detachably and electrically to the adapter, comprising a plurality of light emitting devices that emit light according to the driving power and the control signal.

The present application claims priority under 35 U.S.C. §119(e) of Korean Patent Application No. 10-2008-0111907 (filed on Nov. 11, 2008), No. 10-2008-0111909 (filed on Nov. 11, 2008) and No. 10-2009-0001713 (filed on Jan. 9, 2009), and U.S. Provisional Application No. 61/113,531 (filed on Nov. 11, 2008) and No. 61/113,529 (filed on Nov. 11, 2008) which are hereby incorporated by reference in its entirety.

### BACKGROUND

### Description of the Related Art

Embodiments of the invention relate to an illumination apparatus.

At the present time, a fluorescent lamp or an incandescent lamp has been widely used as an illumination apparatus. In particular, the fluorescent lamp has low power consumption and high brightness so that it has been widely used at office or at home.

Meanwhile, an illumination apparatus that replaces the fluorescent lamp or the incandescent lamp has been recently developed and, representatively, an illumination apparatus using a light emitting diode (LED) has been introduced.

However, in the case of the illumination apparatus using the LED, it is driven with different voltage from the fluorescent lamp or the incandescent lamp, causing a problem that all of power supply apparatus including conventionally installed sockets should be replaced when using the illumination apparatus using the LED.

### SUMMARY OF THE INVENTION

Embodiments of the invention provide an illumination apparatus using an LED or OLED.

Embodiments provide an illumination apparatus using an LED or OLED that can be used without replacing a conventional power supply apparatus installed for a fluorescent lamp.

Embodiments provide an illumination apparatus that can compatibly use various light emitting device illumination parts by detachably installing an adapter and a light emitting device illumination part.

Embodiments provide an illumination apparatus that can control the color, brightness, chroma, blinking, etc. of light emitted from a light emitting device illumination part.

Embodiments provide an illumination apparatus that emits various colors of light by controlling a plurality of light emitting devices that emit red, green, blue, and white light.

Embodiments provide an illumination apparatus that can be remotely controlled.

Embodiments provide an illumination apparatus that can perform an infrared sensing function, a monitoring camera function, and/or a fire sensing function, and a method of driving a function block in an illumination apparatus.

An illumination apparatus according to various embodiments includes an adapter that converts alternating power into driving power; a communication unit connected to the adapter and configured to communicate with a remote controller; a controller connected to the communication unit and configured to generate a control signal according to a control command from the communication unit; and a light emitting device illumination part configured to be connected detachably and electrically to the adapter, comprising a plurality of light emitting devices that emit light according to the driving power and the control signal.

An illumination apparatus according to various embodiments includes an adapter that converts commercial power to driving power; and a LED illumination part configured to be coupled detachably to the adapter, comprising a plurality of LEDs that emit light according to the driving power, wherein the adapter includes a function block comprising at least one of an infrared sensor, an image sensor, and a fire sensor; a communication unit configured to communicate with a remote controller; and a controller connected to the function block and the communication unit, configured to control the function block and the LED illumination part according to the control command.

An illumination apparatus according to various embodiments includes an adapter configured to be coupled detachably and electrically to an illumination apparatus socket; a power supply unit in the adapter, configured to supply power; a light emitting device driver in the adapter, configured to generate driving power using the power from the power supply unit; a light emitting device illumination part configured to be connected to the adapter and that includes a plurality of light emitting devices driven by the driving power from the light emitting device driver; a function block connected to the adapter and that comprises at least one of an infrared sensor, an image sensor, a motion sensor, and a thermal sensor; and a controller that controls the light emitting device driver and the function block.

A method of driving an illumination apparatus according to various embodiments includes converting applied power to driving power in an adapter; transmitting a user control command from a remote controller to a communication unit connected to the adapter; generating a control signal in the controller according to the control command; and emitting light from a light emitting display illumination part according to the driving power and the control signal.

A method of driving a function block in an illumination apparatus according to various embodiments includes sensing motion with an infrared sensor, a thermal sensor, or a motion sensor; transmitting a signal corresponding to the sensed motion to a controller; outputting an activation signal to an alarm from the controller; and photographing an image using an image sensor receiving a command from the controller.

A method of driving a function block in an illumination apparatus according to various embodiments includes sensing heat or fire through a smoke sensor or a thermal sensor; transmitting a signal corresponding to the sensed heat or fire to a controller; and outputting an activation signal to an alarm from the controller.

A method of driving a function block in an illumination apparatus according to various embodiments includes periodically photographing an image using an image sensor; and periodically photographing the image more frequently as motion is sensed through an infrared sensor, a thermal sensor, or a motion sensor in electrical communication with a controller, the controller being in electrical communication with the image sensor.

### BRIEF DESCRIPTION OF THE DRAWINGS

FIG. 1 is a diagram explaining an illumination apparatus according to the first embodiment.

FIG. 2 is a perspective view of the illumination apparatus according to the first embodiment.

FIG. 3 is a diagram explaining the adapter in the illumination apparatus according to the first embodiment.

FIG. 4 is a diagram explaining an example of a surge voltage absorber in the illumination apparatus according to the first embodiment.

FIG. 5 is a diagram showing the AC-DC converter and the regulator of the adapter in the illumination apparatus according to the first embodiment.

FIG. 6 is a diagram explaining an example of the LED driver in the illumination apparatus according to the first embodiment.

FIGS. 7 to 9 are diagrams explaining another example of the illumination apparatus according to the first embodiment.

FIG. 10 is a diagram explaining an illumination apparatus according to a second embodiment.

FIG. 11 is a cross-sectional view of the illumination apparatus according to the second embodiment.

FIG. 12 is a diagram explaining the adapter in the illumination apparatus according to the second embodiment.

FIG. 13 is a diagram explaining another example of the illumination apparatus according to the second embodiment.

FIG. 14 is a diagram explaining an illumination apparatus according to a third embodiment.

FIG. 15 is a perspective view of the illumination apparatus according to the third embodiment.

FIG. 16 is a diagram explaining the adapter in the illumination apparatus according to the third embodiment.

FIG. 17 is a diagram explaining an illumination apparatus according to a fourth embodiment.

FIG. 18 is a perspective view of the illumination apparatus according to the fourth embodiment.

FIG. 19 is a block diagram explaining the constitution of the illumination apparatus according to the fourth embodiment.

FIG. 20 is a diagram showing the light emitting device unit and the lamp information generator in the illumination apparatus according to the fourth embodiment.

FIG. 21 is a diagram showing the function block in the illumination apparatus according to the fourth embodiment.

FIG. 22 is a diagram showing a functional viewpoint of the function block in the illumination apparatus according to the fourth embodiment.

FIG. 23 is a flowchart performing the intruder sensing function in the illumination apparatus according to the fourth embodiment.

FIG. 24 is a flowchart performing the fire sensing function in the illumination apparatus according to the fourth embodiment.

FIG. 25 is a flowchart performing the monitoring camera function in the illumination apparatus according to the fourth embodiment.

FIG. 26 is a diagram explaining an illumination apparatus according to a fifth embodiment.

FIG. 27 is a cross-sectional view of the illumination apparatus according to the fifth embodiment.

FIG. 28 is a block diagram explaining the constitution of the illumination apparatus according to the fifth embodiment.

### DETAILED DESCRIPTION OF THE EMBODIMENTS

In the drawings, the thickness or size of each layer is exaggerated, omitted or schematically illustrated for the convenience and clarity of explanation. Also, the size of each constituent does not completely reflect its actual size.

Hereinafter, an illumination apparatus according to various embodiments will be described with reference to the accompanying drawings.

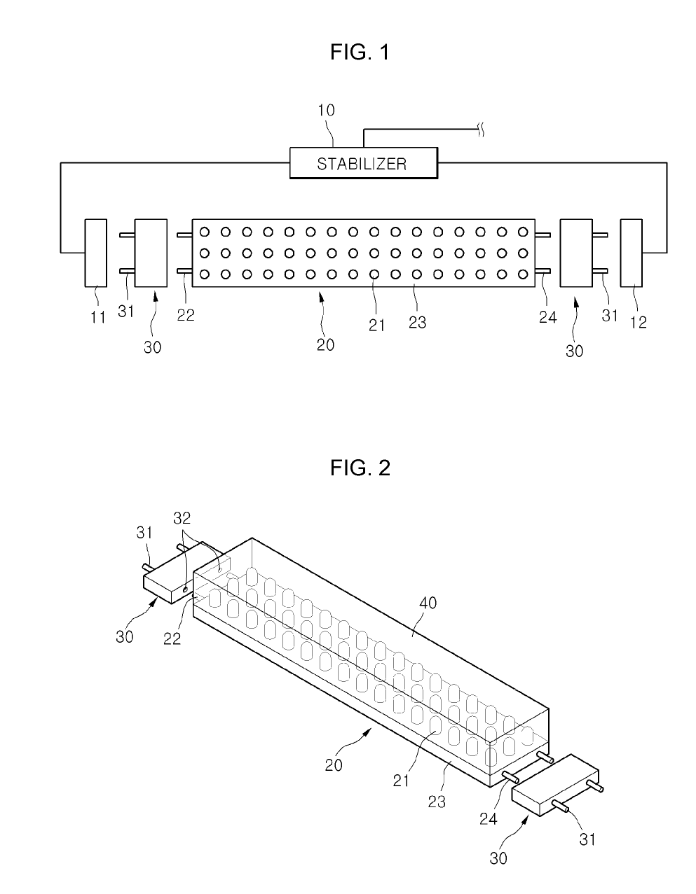

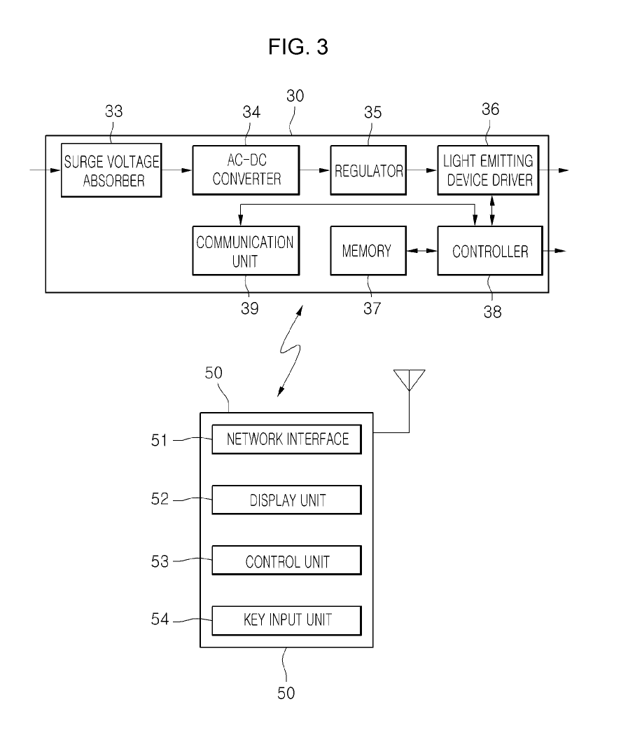

FIG. 1 is a diagram explaining an illumination apparatus according to the first embodiment, FIG. 2 is a perspective view of the illumination apparatus according to the first embodiment, and FIG. 3 is a diagram explaining an adapter in the illumination apparatus according to the first embodiment.

First, referring to FIGS. 1 and 2, the illumination apparatus according to the first embodiment includes alight emitting device illumination part 20 in which a first power terminal 22 and a second power terminal 24 are formed at opposite ends of a substrate 23 and a plurality of light emitting devices 21 are on the top surface of the substrate 23, and an adapter 30 coupled at both sides of the light emitting device illumination part 20. Also, a cover 40 that protects the light emitting devices 21 may further be installed on the substrate 23

In the light emitting device illumination part 20, the plurality of light emitting devices 21 are arranged on the substrate 23. The light emitting devices 21 may be LED or OLED.

The substrate 23 may be a printed circuit board (PCB) on which a circuit pattern for providing power to the light emitting devices 21 is formed. Also, the substrate 23 may be a substrate that a wiring for providing power to the light emitting devices 21 is installed on a plastic instrument.

Moreover, a reflective coating layer (not shown) maybe formed on the surface of the substrate 23, making it possible to increase efficiency of light emitted from the light emitting devices 21 by coating it with silver (Ag) or aluminum (Al).

The plurality of light emitting devices 21 may include LED or OLED that emit red, blue, and green light, and may also include LED or OLED that emit white light.

The cover 40 may comprise transparent plastic material, and may also comprise plastic with various colors such as red, green, blue, etc., as needed. Also, the cover 40 may comprise translucent material and in this case, it may also provide an illumination with a soft atmosphere.

The first and second power terminals 22 and 24 that can be electrically connected to the adapter 30 are installed at both ends of the substrate 23, thereby supplying power to the light emitting devices 21 from the outside.

The adapter 30 includes a connector 31 formed at one side and inserted into a first socket 11 and a second socket 12 that install a conventional fluorescent lamp, and a power terminal groove or socket 32 formed at the other side and into which the first and second power terminals 22 and 24 of the light emitting device illumination part 20 are inserted.

The light emitting device illumination part 20 is coupled to the adapter 30 so that the illumination apparatus according to the first embodiment can be installed at the first and second sockets 11 and 12 where a conventional fluorescent lamp is installed. Therefore, although a power supply apparatus including the first and second sockets 11 and 12 where the conventional fluorescent lamp is installed is not replaced, an illumination apparatus using an LED or OLED can be used.

In particular, since the light emitting device illumination part 20 and the adapter 30 are detachably installed, when defects are generated on the light emitting device illumination part 20 or the adapter 30, only the light emitting device illumination part 20 or the adapter 30 where the defects are generated can be replaced, having low maintenance costs.

Moreover, since the light emitting device illumination part 20 and the adapter 30 are detachably installed, illuminations with various atmospheres can be provided by replacing only the light emitting device illumination part 20.

Referring to FIG. 3, the adapter 30 includes a surge voltage absorber 33, an AC-DC converter 34, a regulator 35, a light emitting device driver 36, a memory 37, a controller 38, and a communication unit 39.

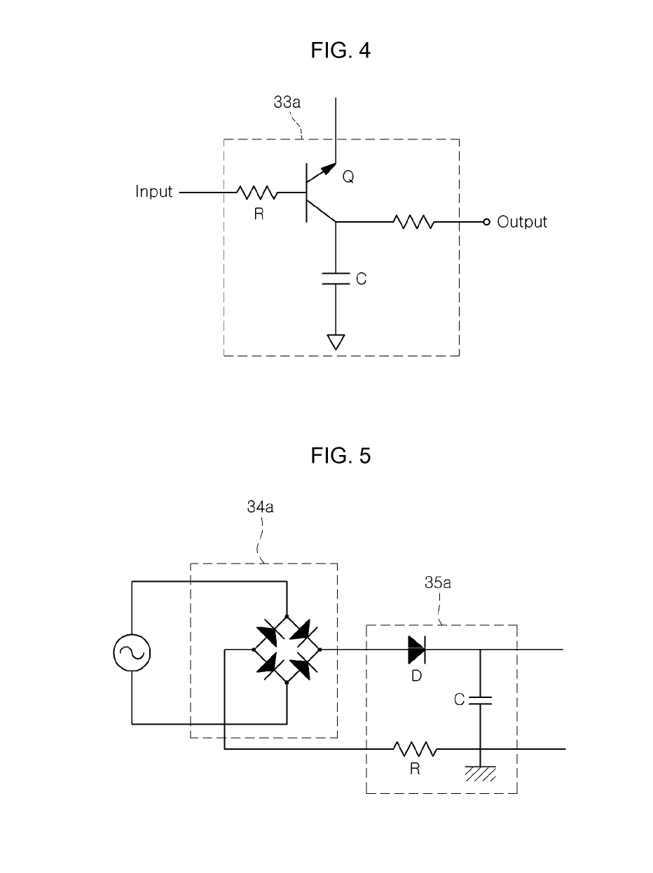

The surge voltage absorber 33 is installed to absorb surge voltage when the surge voltage to turn on a fluorescent lamp is applied from a stabilizer 10, and, for example, it may include a surge voltage absorption circuit 33a as shown in FIG. 4.

The AC-DC converter 34 converts AC power supplied through the first and second sockets 11 and 12 into DC power, and the regulator 35 allows the DC power output from the AC-DC converter 34 to be output as constant DC voltage. For example, as shown in FIG. 5, the AC-DC converter 34 and the regulator 35 may include a bridge rectifier 34a and a smoothing circuit 35a.

The light emitting device driver 36 outputs the DC voltage supplied from the regulator 35 as one or more driving pulses configured to drive the plurality of light emitting devices 21.

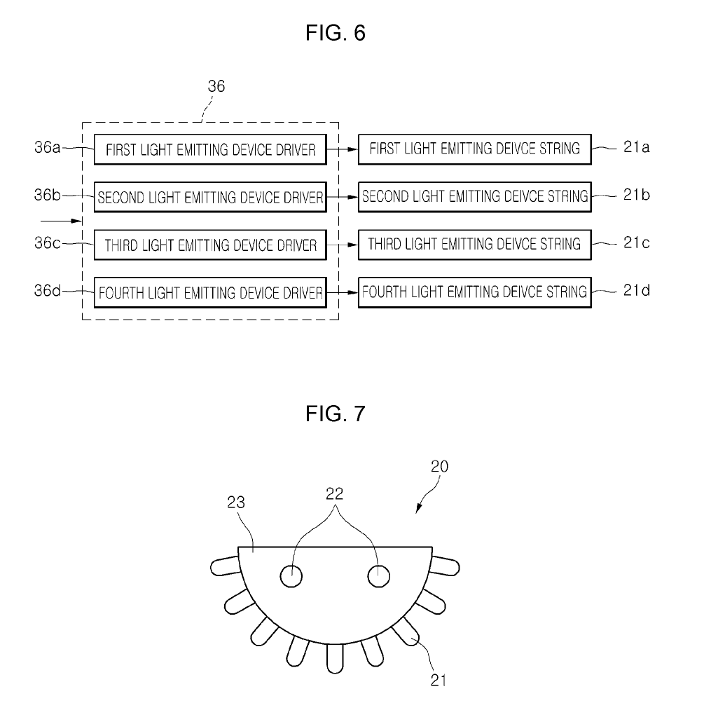

Referring to FIG. 6, the light emitting device driver 36 includes a first light emitting device driver 36a, a second light emitting device driver 36b, a third light emitting device driver 36c, and a fourth light emitting device driver 36d, wherein the first light emitting device driver 36a, the second light emitting device driver 36b, the third light emitting device driver 36c, and the fourth light emitting device driver 36d drive a first light emitting device string 21a, a second light emitting device string 21b, a third light emitting device string 21c, and a fourth light emitting device string 21d on the light emitting device illumination part 20, respectively.

For example, the first light emitting device string 21a may be formed by connecting a plurality of LEDs or OLEDs that emit red light in series, the second light emitting device string 21b may be formed by connecting a plurality of LEDs or OLEDs that emit green light in series, the third light emitting device string 21c may be formed by connecting a plurality of LEDs or OLEDs that emit blue light in series, and the fourth light emitting device string 21d may be formed by connecting a plurality of LEDs or OLEDs that emit white light in series.

The light emitting device driver 36 controls the first light emitting device driver 36a, the second light emitting device driver 36b, the third light emitting device driver 36c, and the fourth light emitting device driver 36d to control the length, interval, etc. of the driving pulses of the first light emitting device string 21a, the second light emitting device string 21b, the third light emitting device string 21c, and the fourth light emitting device string 21d, allowing various colors of light to be emitted.

For example, if the driving pulse is applied to only the first light emitting device string 21a by driving only the first light emitting device driver 36a, red light is emitted from the light emitting device illumination part 20.

Moreover, if the driving pulse is applied to only the fourth light emitting device string 21d by driving only the fourth light emitting device driver 36d, white light is emitted from the light emitting device illumination part 20. Also, if the driving pulse is applied to the first light emitting device string 21a, the second light emitting device string 21b, the third light emitting device string 21c, and the fourth light emitting device string 21d by driving the first light emitting device driver 36a, the second light emitting device driver 36b, the third light emitting device driver 36c, and the fourth light emitting device driver 36d, brighter white light is emitted from the light emitting device illumination part 20.

Information for driving the plurality of light emitting devices 21 is stored in the memory 37. For example, driving pulse information output from the first light emitting device driver 36a, the second light emitting device driver 36b, the third light emitting device driver 36c, and the fourth light emitting device driver 36d may be stored in the memory 37.

The controller 38 extracts the driving pulse information stored in the memory 37 and controls the first light emitting device driver 36a, the second light emitting device driver 36b, the third light emitting device driver 36c, and the fourth light emitting device driver 36d to drive the first light emitting device string 21a, the second light emitting device string 21b, the third light emitting device string 21c, and the fourth light emitting device string 21d.

For example, the controller 38 provides different driving pulse information to the first light emitting device driver 36a, the second light emitting device driver 36b, the third light emitting device driver 36c, and the fourth light emitting device driver 36d, making it possible to control the color, brightness, chroma, blinking, etc. of light emitted from the plurality of light emitting devices 21.

The communication 39 performs communication with the remote controller 50 and the controller 38 is remotely controlled by the remote controller 50. For example, the communication unit 39 and the remote controller 50 can perform communication according to Zigbee standard.

The remote controller 50 includes a network interface 51 that transmits data to the communication unit 39, a key input unit 54 into which a user operation command is input, a display unit 52 that displays a user operation state, and a control unit 53 that controls the network interface 51 and the display unit 52 according to the signal of the key input unit 54.

Therefore, as the user transmits the control command to the communication unit 39 using the remote controller 50, the communication unit 39 transmits the user control command to the controller 38, making it possible to control the light emitting device illumination part 20.

For example, the user can allow the first light emitting device driver 36a, the second light emitting device driver 36b, the third light emitting device driver 36c, and the fourth light emitting device driver 36d to be selectively driven using the remote controller 50 so that a specific color of light is emitted from the light emitting device illumination part 20.

Moreover, the user can allow the light emitting device illumination part 20 to be turned on or turned off after a predetermined time elapses, using the remote controller 50. In other words, by inputting a timer function, the user can allow the controller 38 to control the light emitting device driver 36 according to the change of time.

The illumination apparatus according to the first embodiment can also be used in the power supply apparatus for the conventional fluorescent lamp to which AC power is provided, by the adapter 30 including the surge voltage absorber 33, the AC-DC converter 34, the regulator 35, and the light emitting device driver 36.

In other words, as shown in FIG. 1, the power supply apparatus for the fluorescent lamp includes a stabilizer 10 that converts commercial power into high frequency current of 20-50 kHz and first and second sockets 11 and 12 connected to the stabilizer 10, wherein only high frequency AC current is provided through the first and second sockets 11 and 12 so that the light emitting device illumination part 20 cannot be installed directly on the conventional power supply apparatus. However, the illumination apparatus according to the first embodiment installs the adapter 30, making it possible to use the light emitting device illumination part 20, while using the conventional power supply apparatus as it is.

Furthermore, the illumination apparatus according to the first embodiment can diversely control the color, brightness, chroma, blinking, etc. of the light emitted from the light emitting device illumination part 20 by the adapter 30 including the memory 37, the controller 38, and the light emitting device driver 36.

Moreover, the illumination apparatus according to the first embodiment can be controlled remotely by the adapter 30 including the communication unit 39 that performs communication with the remote controller 50.

In addition, since the adapter 30 and the light emitting device illumination part 20 are detachable, the illumination apparatus can be used to be connected to only the light emitting device illumination part 20 by separating the adapter 30 from the light emitting device illumination part 20 where the power supply apparatus for the light emitting device illumination part 20 is installed.

FIGS. 7 to 9 are diagrams explaining another example of the light emitting device illumination part in the illumination apparatus according to the first embodiment. FIGS. 7 to 9 are side views of the light emitting device illumination part seen from the direction where the adapter is disposed.

Referring to FIG. 7, a light emitting device illumination part 20 includes a substrate 23 whose cross-section has a semicircular shape and a plurality of light emitting devices 21 installed at the semicircle surface of the substrate 23, wherein a first power terminal 22 is installed at ends of the substrate 23.

In FIG. 7, the substrate 23 has a semicircular shape and the light emitting devices 21 are installed at the curved part, such that the light emitting device illumination part 20 is proper in being used in an environment where it is effective to provide illumination only downward. For example, when the light emitting device illumination part 20 is installed at a ceiling or the like, light efficiency can be increased.

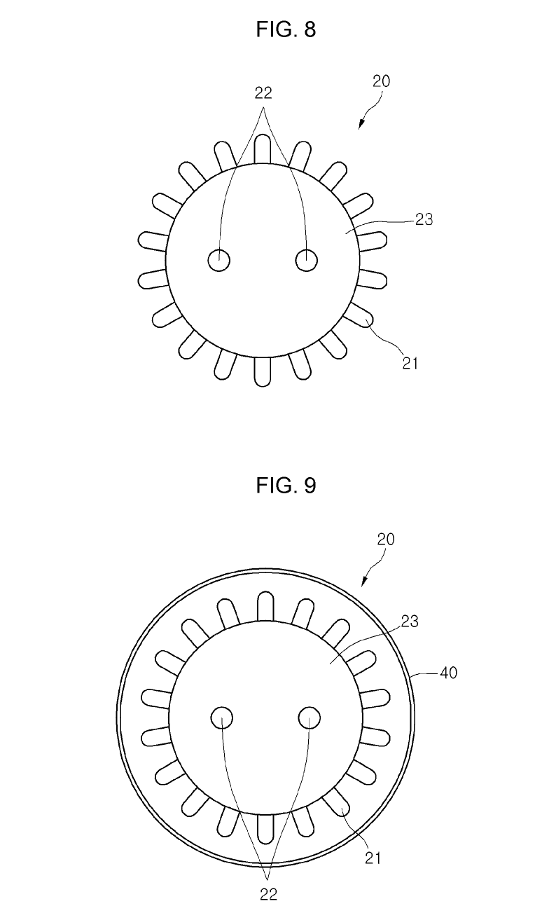

Referring to FIG. 8, a light emitting device illumination part 20 includes a substrate 23 whose cross-section has a circular shape and a plurality of light emitting devices 21 installed at the circular surface of the substrate 23, wherein a first power terminal 22 is installed at ends of the substrate 23.

In FIG. 8, the substrate 23 has a circular shape and the light emitting devices 21 are installed at the curved part, such that the light emitting device illumination part 20 is proper in being used in an environment where it is effective to provide illumination in 360° directions. For example, when the light emitting device illumination part 20 is installed at an advertisement facility in a cylindrical shape, light efficiency can be increase. The light emitting device illumination part 20 as shown in FIG. 8 may also be used as home illumination of office illumination.

Referring to FIG. 9, a light emitting device illumination part 20 includes a substrate 23 whose cross-section has a circular shape and a plurality of light emitting devices 21 installed at the circular surface of the substrate 23, wherein a first power terminal 22 is installed at ends of the substrate 23. Also, a cover 40 that protects the light emitting devices 21 is further included.

The cover 40 is installed to be spaced from the light emitting devices 21 at a predetermined interval, making it possible to protect the light emitting devices 21 from external impact or environmental change. The cover 40 may also comprise transparent or translucent plastic material.

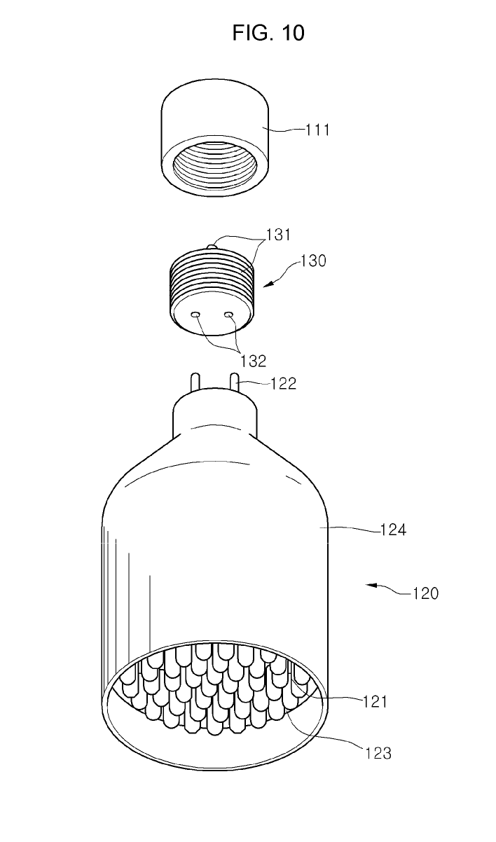

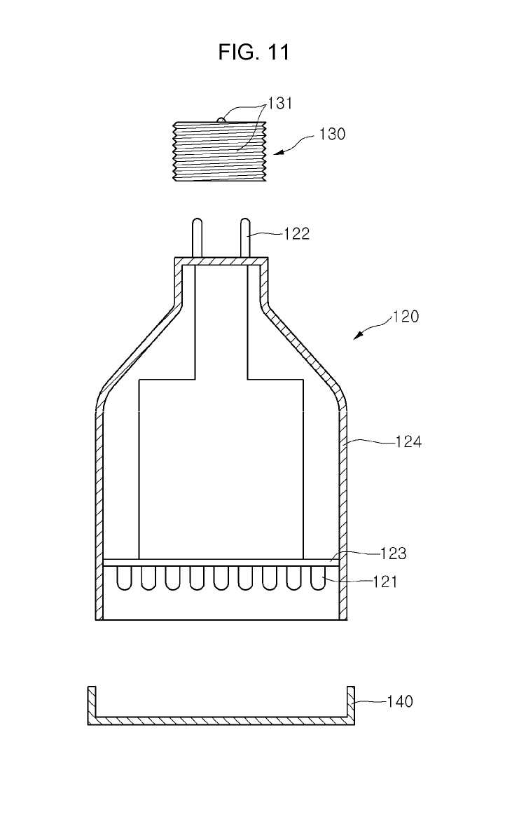

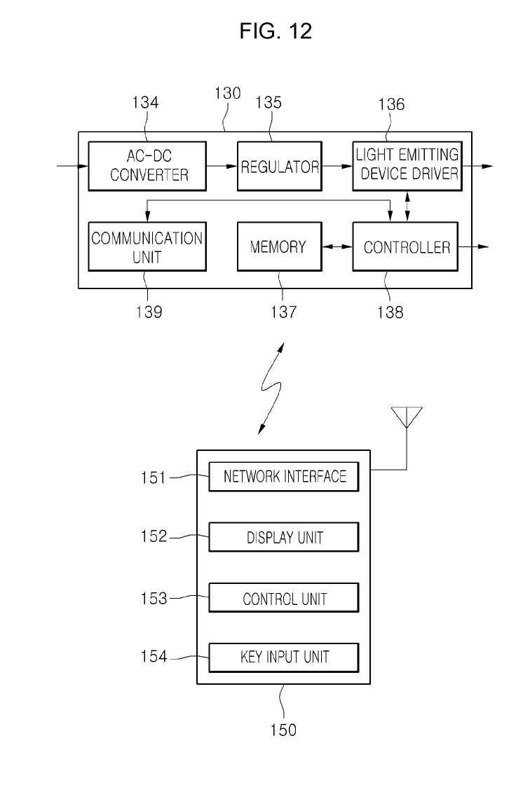

FIG. 10 is a diagram explaining an illumination apparatus according to a second embodiment, FIG. 11 is a cross-sectional view of the illumination apparatus according to the second embodiment, and FIG. 12 is a diagram explaining the adapter in the illumination apparatus according to the second embodiment.

First, referring to FIGS. 10 and 11, the illumination apparatus according to the second embodiment includes an adapter 130 that can be coupled to a socket 111 at which an incandescent lamp or a halogen lamp can be installed and a light emitting device illumination part 120 that is coupled detachably to the adapter 30.

The adapter 130 has a connector 131 having a shape that can be coupled to the socket 111, having a spiral projection, and connected electrically to the socket 111, and a power terminal groove or socket 132 to which the light emitting device illumination part 120 is coupled to be electrically connected.

The light emitting device illumination part 120 includes a power terminal 122 inserted into the power terminal groove or socket 132 to be electrically connected, a housing 124 at which the power terminal 122 is installed, a substrate 123 coupled to the housing 124, and a plurality of light emitting devices 121 installed on the substrate 123. The light emitting device illumination part 120 may further include a cover 140 coupled to the housing 124 in order to protect the plurality of light emitting devices 121.

The substrate 123 may be a printed circuit board (PCB) on which a circuit pattern for providing power to the light emitting devices 121 is formed. Also, the substrate 123 may be a substrate that a wiring for providing power to the light emitting devices 121 is installed on a plastic instrument. The substrate 123 is connected electrically to the power terminal 122.

Moreover, a reflective coating layer (not shown) may be formed on the surface of the substrate 123, making it possible to increase efficiency of light emitted from the light emitting devices 121 by coating it with silver (Ag) or aluminum (Al).

In the second embodiment, the substrate 123 has a plate shape to be inserted into the inside of the housing 124. Therefore, when the cover 140 is coupled to the housing 124, the substrate 123 and the light emitting devices 121 installed on the substrate 123 are surrounded by the housing 124 and the cover 140.

The plurality of light emitting devices 121 may include LED or OLED that emit red, blue, and green light, and may also include LED or OLED that emit white light.

The cover 140 may comprise transparent plastic material, and may also comprise plastic with various colors such as red, green, blue, etc., according to designs. Also, the cover 140 may comprise translucent material and in this case, it may also provide an illumination with a soft atmosphere.

As the light emitting device illumination part 120 is coupled to the adapter 130, the illumination apparatus according to the second embodiment can be installed at the socket 111 at which the conventional incandescent lamp or the halogen lamp is installed.

Moreover, as the adapter 130 converts AC power applied to the conventional incandescent lamp or halogen lamp into DC power, the illumination apparatus according to the second embodiment allows the light emitting devices 121 to be driven.

Therefore, although a power supply apparatus including the socket 111 where the conventional incandescent lamp or halogen lamp is installed is not replaced, an illumination apparatus using LED can be used.

In particular, since the light emitting device illumination part 120 and the adapter 130 are detachably installed, when defects are generated on the light emitting device illumination part 120 or the adapter 130, only the light emitting device illumination part 120 or the adapter 130 where the defects are generated can be replaced, having low maintenance costs.

Moreover, since the light emitting device illumination part 120 and the adapter 130 are detachably installed, illuminations with various atmospheres can be provided by replacing only the light emitting device illumination part 120.

Referring to FIG. 12, the adapter 130 includes an AC-DC converter 134, a regulator 135, a light emitting device driver 136, a memory 137, a controller 138, and a communication unit 139.

The AC-DC converter 134 converts AC power supplied through the socket 111 into DC power, and the regulator 135 allows the DC power output from the AC-DC converter 134 to be output as constant DC voltage. For example, as shown in FIG. 5, the AC-DC converter 134 and the regulator 135 include a bridge rectifier 34a and a smoothing circuit 35a to allow constant DC voltage to be output.

The light emitting device driver 136 outputs the DC voltage supplied from the regulator 135 as driving pulse proper in driving the plurality of light emitting devices 121.

As explained in FIG. 6, the light emitting device driver 136 may include the first light emitting device driver, the second light emitting device driver, the third light emitting device driver, and the fourth light emitting device driver, wherein the first light emitting device driver, the second light emitting device driver, the third light emitting device driver, and the fourth light emitting device driver drive a first light emitting device string, a second light emitting device string, a third light emitting device string, and a fourth light emitting device string on the light emitting device illumination part 120, respectively.

The operation of the light emitting device driver 136 is the same as that of the light emitting device driver 36 in the first embodiment so that the overlapping explanation will be omitted.

Information for driving the plurality of light emitting devices 121 is stored in the memory 137. For example, driving pulse information output from the first light emitting device driver, the second light emitting device driver, the third light emitting device driver, and the fourth light emitting device driver of the light emitting device driver 136 may be stored in the memory 137.

The controller 138 extracts the driving pulse information stored in the memory 137 and controls the first light emitting device driver, the second light emitting device driver, the third light emitting device driver, and the fourth light emitting device driver to drive the first light emitting device string, the second light emitting device string, the third light emitting device string, and the fourth light emitting device string.

For example, the controller 138 provides different driving pulse information to the first light emitting device driver, the second light emitting device driver, the third light emitting device driver, and the fourth light emitting device driver, making it possible to control the color, brightness, chroma, blinking, etc. of light emitted from the plurality of light emitting devices 121.

The communication 139 performs communication with the remote controller 150 and the controller 138 is remotely controlled by the remote controller 150. For example, the communication unit 139 and the remote controller 150 can perform communication according to Zigbee standard.

The remote controller 150 includes a network interface 151 that transmits data to the communication unit 139, a key input unit 154 into which a user operation command is input, a display unit 152 that displays a user operation state, and a control unit 153 that controls the network interface 151 and the display unit 152 according to the signal of the key input unit 154.

Therefore, as the user transmits the control command to the communication unit 139 using the remote controller 150, the communication unit 139 transmits the user control command to the controller 138, making it possible to control the light emitting device illumination part 120.

Therefore, the illumination apparatus according to the second embodiment can also be used in the power supply apparatus for the conventional incandescent lamp or halogen lamp to which AC power is supplied, by the adapter 130 including the AC-DC convert 134, the regulator 135, and the light emitting device driver 136.

Moreover, the illumination apparatus according to the second embodiment can diversely control the color, brightness, chroma, blinking, etc. of the light emitted from the light emitting device illumination part 120 by the adapter 130 including the memory 137, the controller 138, and the light emitting device driver 136.

Furthermore, the illumination apparatus according to the second embodiment can be controlled remotely by the adapter 130 including the communication unit 139 that performs communication with the remote controller 150.

In addition, since the adapter 130 and the light emitting device illumination part 120 are detachable, the illumination apparatus can be used to be connected to only the light emitting device illumination part 120 by separating the adapter 130 from the light emitting device illumination part 120 where the power supply apparatus for the light emitting device illumination part 120 is installed.

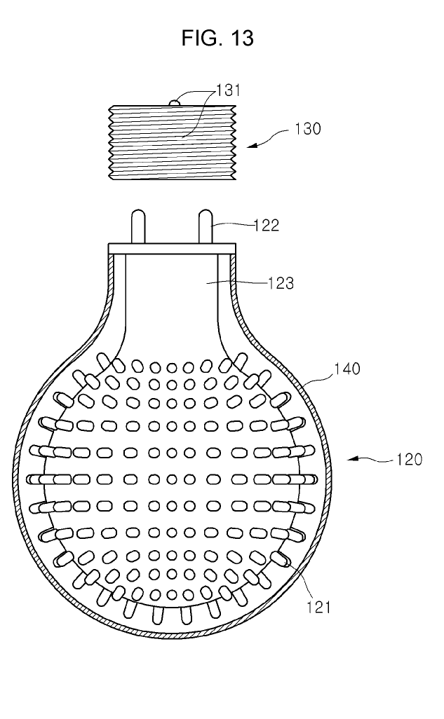

FIG. 13 is a diagram explaining another example of the illumination apparatus according to the second embodiment.

When explaining the illumination apparatus shown in FIG. 13, the explanation overlapping with the contents explained in FIGS. 10 and 11 will be omitted.

Referring to FIG. 13, a light emitting device illumination part 120 includes a substrate 123 having a spherical shape and a plurality of light emitting devices on the spherical surface of the substrate 123, wherein a power terminal 122 is installed at one side of the substrate 123. Also, a cover 140 that surrounds the substrate 123 and is spaced from the light emitting devices 121 at a predetermined interval may further be included.

The light emitting device illumination part 120 installs the plurality of light emitting devices 121 at the surface of the substrate 123 having a spherical shape, making it possible to provide illumination to positions having a wide angle.

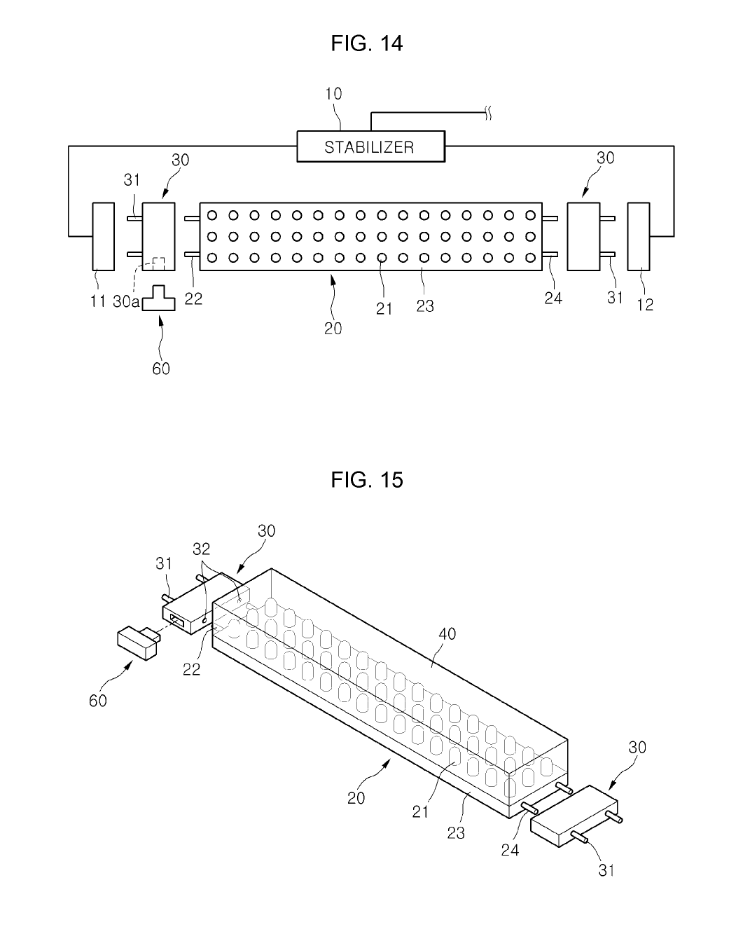

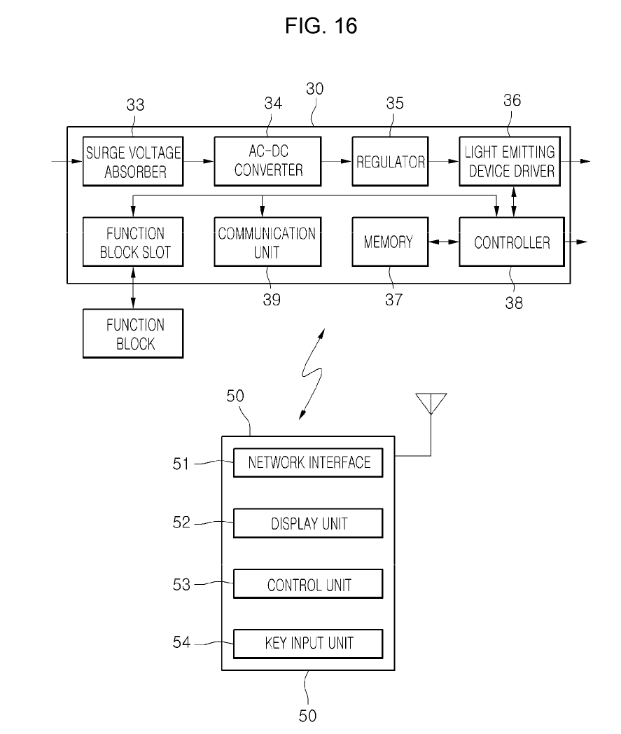

FIG. 14 is a diagram explaining an illumination apparatus according to a third embodiment, FIG. 15 is a perspective view of the illumination apparatus according to the third embodiment, and FIG. 16 is a diagram explaining the adapter in the illumination apparatus according to the third embodiment.

First, referring to FIGS. 14 and 15, the illumination apparatus according to the third embodiment includes alight emitting device illumination part 20 in which a first power terminal 22 and a second power terminal 24 are formed at opposite ends of a substrate 23 and a plurality of light emitting devices 21 are on the top surface of the substrate 23, and an adapter 30 coupled at sides of the light emitting device illumination part 20. Also, a cover 40 that protects the light emitting devices 21 may further be installed on the substrate 23.

In the light emitting device illumination part 20, the plurality of light emitting devices 21 are arranged on the substrate 23. The light emitting devices 21 may be LED or OLED.

The substrate 23 may be a printed circuit board (PCB) on which a circuit pattern for providing power to the light emitting devices 21 is formed. Also, the substrate 23 may be a substrate that a wiring for providing power to the light emitting devices 21 is installed on a plastic instrument.

Moreover, a reflective coating layer (not shown) maybe formed on the surface of the substrate 23, making it possible to increase efficiency of light emitted from the light emitting devices 21 by coating it with silver (Ag) or aluminum (Al).

The plurality of light emitting devices 21 may include LED or OLED that emit red, blue, and green light, and may also include LED or OLED that emit white light.

The cover 40 may comprise transparent plastic material, and may also comprise plastic with various colors such as red, green, blue, etc., as needed. Also, the cover 40 may comprise translucent material and in this case, it may also provide an illumination with a soft atmosphere.

The first and second power terminals 22 and 24 that can be electrically connected to the adapter 30 are installed at both ends of the substrate 23, thereby supplying power to the light emitting devices 21 from the outside.

The adapter 30 includes a connector 31 formed at one side and inserted into a first socket 11 and a second socket 12 that install a conventional fluorescent lamp, and a power terminal groove or socket 32 formed at another side and into which the first power terminal 22 of the light emitting device illumination part 20 are inserted. Also, the adapter 30 has a function block slot 30a into which a function block 60 including at least one of an infrared sensor, an image sensor, and a fire sensor can be inserted.

The light emitting device illumination part 20 is coupled to the adapter 30 so that the illumination apparatus according to the third embodiment can be installed at the first and second sockets 11 and 12 where a conventional fluorescent lamp is installed. Therefore, although a power supply apparatus including the first socket 11 where the conventional fluorescent lamp is installed is not replaced, an illumination apparatus using the light emitting device can be used.

In particular, since the light emitting device illumination part 20 and the adapter 30 are detachably installed, when defects are generated on the light emitting device illumination part 20 or the adapter 30, only the light emitting device illumination part 20 or the adapter 30 where the defects are generated can be replaced, having low maintenance costs.

Moreover, since the light emitting device illumination part 20 and the adapter 30 are detachably installed, illuminations with various atmospheres can be provided by replacing only the light emitting device illumination part 20.

Referring to FIG. 16, the adapter 30 includes a surge voltage absorber 33, an AC-DC converter 34, a regulator 35, a light emitting device driver 36, a memory 37, a controller 38, a communication unit 39, and a function block slot 30a. A function block 60 may be inserted into the function block slot 30a.

The surge voltage absorber 33 is installed to absorb surge voltage when the surge voltage to turn on a fluorescent lamp is applied from a stabilizer 10, and, for example, it may include a surge voltage absorption circuit 33a as shown in FIG. 4.

The AC-DC converter 34 converts AC power supplied through the first and second sockets 11 and 12 into DC power, and the regulator 35 allows the DC power output from the AC-DC converter 34 to be output as constant DC voltage. For example, as shown in FIG. 5, the AC-DC converter 34 and the regulator 35 may include a bridge rectifier 34a and a smoothing circuit 35a.

The light emitting device driver 36 outputs the DC voltage supplied from the regulator 35 as driving pulse proper in driving the plurality of light emitting devices 21.

Information for driving the plurality of LED 21 is stored in the memory 37. For example, driving pulse information may be stored in the memory 37.

The controller 38 extracts the driving pulse information stored in the memory 37 to control it.

The communication 39 performs communication with the remote controller 50 and the controller 38 is remotely controlled by the remote controller 50. For example, the communication unit 39 and the remote controller 50 can perform communication according to Zigbee standard.

The remote controller 50 includes a network interface 51 that transmits data to the communication unit 39, a key input unit 54 into which a user operation command is input, a display unit 52 that displays a user operation state, and a control unit 53 that controls the network interface 51 and the display unit 52 according to the signal of the key input unit 54.

Therefore, as the user transmits the control command to the communication unit 39 using the remote controller 50, the communication unit 39 transmits the user control command to the controller 38, making it possible to control the light emitting device illumination part 20.

Moreover, the user can allow the light emitting device illumination part 20 to be turned on or turned off after a predetermined time elapses, using the remote controller 50. In other words, by inputting a timer function, the user can allow the controller 38 to control the light emitting device driver 36 according to the change of time.

The function block 60 is coupled detachably to the function block slot 30a of the adapter 30, making it possible to be connected to the controller 38. At least one of an infrared sensor, an image sensor, and a fire sensor may be installed at the function block 60.

For example, the function block 60 is stalled with the infrared sensor to perform a security function, wherein when the motion of a human is sensed by the infrared sensor, it transmits the sensed signal to the controller 38, and the controller 38 can transmit the sensed information to the remote controller 50 through the communication unit 39.

Moreover, the function block 60 is stalled with the image sensor to perform a security function, wherein the image obtained by the image sensor is transmitted to the controller 38, and the controller 38 can store the image or transmit the image to the remote controller 50 through the communication unit 39.

Furthermore, the function block 60 is stalled with the fire sensor to perform a fire sensing function, wherein when fire is sensed through the fire sensor, it transmits the sensed signal to the controller 38, and the controller 38 can transmit the sensed information to the remote controller 50 through the communication unit 39. Alternately, a speaker (not shown) is installed at the adapter 30 so that a fire alarm can be output from the speaker by the controller 38 obtaining the fire sensing signal.

The user can, of course, perform various controls including the turn-on/turn-off of the operation of the function block 60 through the remote controller 50.

The illumination apparatus according to the third embodiment can also be used in the power supply apparatus for the conventional fluorescent lamp to which AC power is provided, by the adapter 30 including the surge voltage absorber 33, the AC-DC converter 34, the regulator 35, and the light emitting device driver 36.

In other words, as shown in FIG. 14, the power supply apparatus for the fluorescent lamp includes a stabilizer 10 that converts commercial power into high frequency current of 20-50 kHz and twp sockets 11 connected to the stabilizer 10, wherein only high frequency AC current is provided through the first sockets 11 so that the light emitting device illumination part 20 cannot be installed directly on the conventional power supply apparatus. However, the illumination apparatus according to certain embodiments installs the adapter 30, making it possible to use the light emitting device illumination part 20, while using the conventional power supply apparatus as it is.

Furthermore, the illumination apparatus according to the third embodiment can diversely control the color, brightness, chroma, blinking, etc. of the light emitted from the light emitting device illumination part 20 by the adapter 30 including the memory 37, the controller 38, and the light emitting device driver 36.

Moreover, the illumination apparatus according to the third embodiment can be controlled remotely by the adapter 30 including the communication unit 39 that performs communication with the remote controller 50.

In addition, the illumination apparatus according to the third embodiment has the function block slot 30a and the function block 60 that is detachable to the function block slot 30a, making it possible to perform the security function, fire sensing function, etc. together with the illumination function.

Moreover, since the adapter 30 and the light emitting device illumination part 20 are detachable, the illumination apparatus can be used to be connected to only the light emitting device illumination part 20 by separating the adapter 30 from the light emitting device illumination part 20 where the power supply apparatus for the light emitting device illumination part 20 is installed.

Meanwhile, in the third embodiment, at least one of the infrared sensor, the image sensor, and the fire sensor are in the function block 60, but the communication unit 39 and/or the memory 37 may also be in the function block 60 to be detachable to the adapter 30.

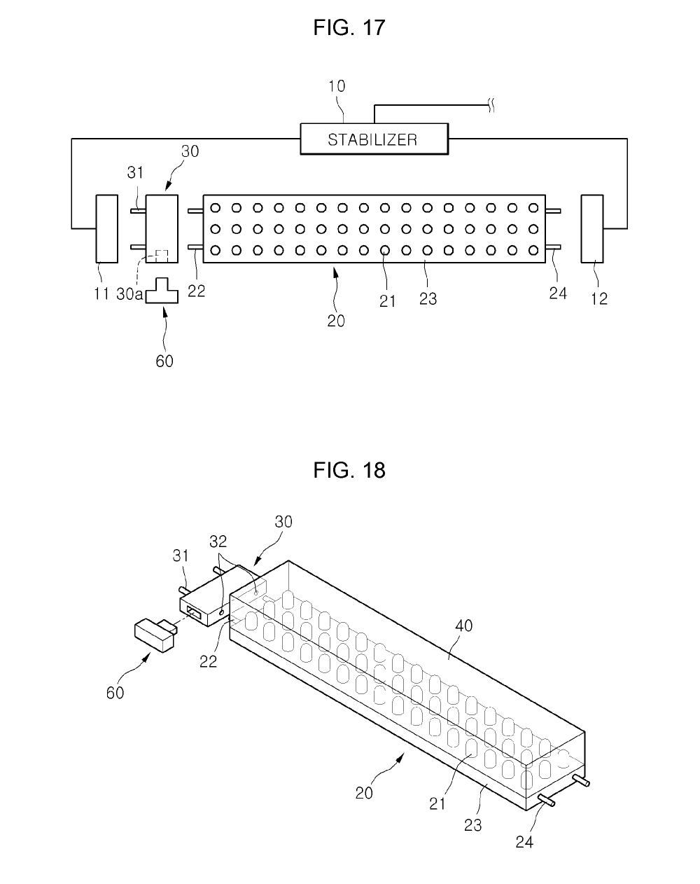

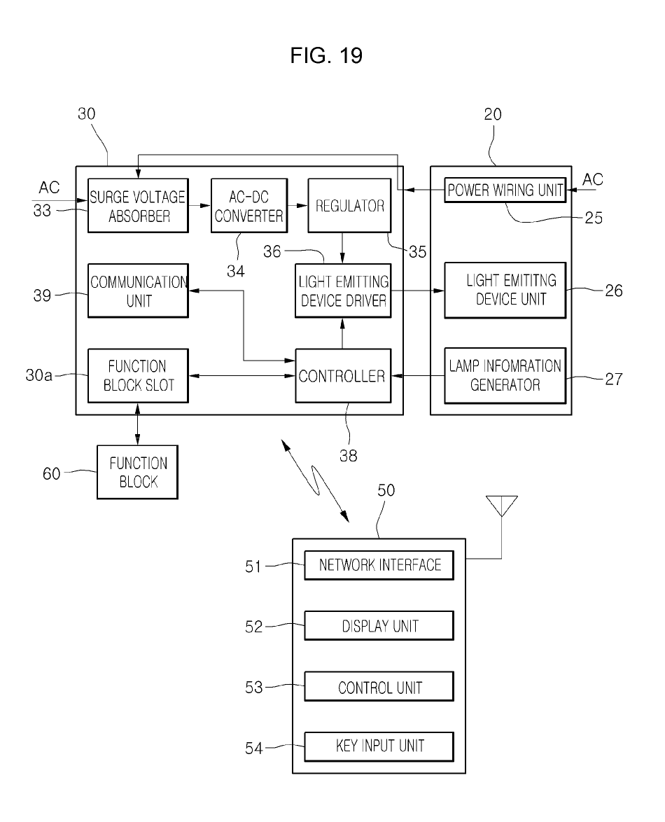

FIG. 17 is a diagram explaining an illumination apparatus according to a fourth embodiment, FIG. 18 is a perspective view of the illumination apparatus according to the fourth embodiment, and FIG. 19 is a block diagram explaining the constitution of the illumination apparatus according to the fourth embodiment.

First, referring to FIGS. 17 and 18, the illumination apparatus according to the fourth embodiment includes a lamp illustrated as a light emitting device illumination part 20 and an adapter 30 that drives the lamp.

In the light emitting device illumination part 20, a plurality of light emitting devices 21 are installed on a substrate 23, wherein a first power terminal 22 connected electrically to the adapter 30 is formed at one side of the substrate 23 and a second power terminal 24 is formed at the other side of the substrate 23. Also, a cover 40 that protects the light emitting devices 21 may further be installed on the substrate 23.

A power terminal groove or socket 32 into which the first power terminal 22 is inserted is formed at one side of the adapter to be coupled to the light emitting device illumination part 20 simultaneously with being connected electrically to the light emitting device illumination part 20. And, a connector 31 is formed at one side of the adapter 30.

The illumination apparatus according to the fourth embodiment is configured to be installable by replacing the conventional fluorescent lamp. In other words, the light emitting device illumination part 20 is coupled to the adapter 30 so that the illumination apparatus according to the fourth embodiment can be installed at the first and second sockets 11 and 12 where the conventional fluorescent lamp is installed. Therefore, although a power supply apparatus including the first and second sockets 11 and 12 where the conventional fluorescent lamp is installed is not replaced, an illumination apparatus using the light emitting devices 21 comprising LEDs or OLEDs can be installed.

At the present time, the first socket 11 and the second socket 12 are provided in the power supply apparatus for installing most of the fluorescent lamps in order to install the fluorescent lamps and provide power, wherein power is provided to the first and second sockets 11 and 12 through a stabilizer 10. Therefore, the illumination apparatus according to the fourth embodiment inserts the connector 31 at the adapter 30 and the second power terminal 24 at the light emitting device illumination unit 20 into the first and second sockets 11 and 12, thereby allowing the illumination apparatus to be connected electrically to the first and second sockets 11 and 12 simultaneously with being supported thereby.

The power provided to the first socket 11 is provided directly to the adapter 30, and the power provided to the second socket 12 is provided to the adapter 30 through the substrate 23 of the light emitting device illumination part 20. And, the adapter 30 receives the power provided from the first socket 11 and the second socket 12 to drive the light emitting device illumination part 20.

In the fourth embodiment, the adapter 30 receives the power provided from the first socket 11 and the second socket 12 to drive the light emitting device illumination part 20, but the adapter 30 is able to drive the light emitting device illumination part 20 with only the power provided from the first socket 11 or the second socket 12.

In the illumination apparatus according to the fourth embodiment, the adapter 30 can recognize the sort of the light emitting device illumination part 20 so that the adapter 30 is provided to adaptively control the light emitting device illumination part 20. Therefore, various models of the light emitting device illumination part 20 produced in various manufacturing companies can be freely selected and used.

In the light emitting device illumination part 20, a plurality of light emitting devices 21 are arranged on the 867 substrate 23. The light emitting devices 21 may be LED or OLED.

On the substrate 23, a wiring that provides power to the light emitting devices 21 from the adapter 30 and a wiring that provides power provided from the second socket 12 to the adapter 30 may be formed. For example, the substrate 23 may be a printed circuit board (PCB).

The plurality of light emitting devices 21 may include LED or OLED that emit red, blue, green, and white light.

The cover 40 may comprise transparent plastic material, and may also comprise plastic with various colors such as red, green, blue, etc., as needed. Also, the cover 40 may comprise translucent material and in this case, it may also provide an illumination with a soft atmosphere.

In addition, the adapter 30 includes the function block slot 30a into which a function block 60 on which at least one of an infrared sensor, an image sensor, a smoke sensor, a motion sensor, and a thermal sensor is installed can be inserted.

Referring to FIG. 19, in the illumination apparatus according to the fourth embodiment, the adapter 30 includes a surge voltage absorber 33, an AC-DC convert 34, a regulator 35, a light emitting device driver 36, a controller 38, a communication unit 39, and a function block slot 30a, wherein the light emitting device illumination unit 20 may include a power wiring unit 25, a light emitting device unit 26, and a lamp information generator 27.

More specifically, a function block 60 may be inserted into the function block slot 30a of the adapter 30.

The power supply unit that provides power in the adapter 30 includes the surge voltage absorber 33, the AC-DC converter 34, and the regulator 35.

The surge voltage absorber 33 is installed to absorb surge voltage when the surge voltage to turn on a fluorescent lamp is applied from a stabilizer 10, and, for example, it may include a surge voltage absorption circuit 33a as shown in FIG. 4.

The surge voltage absorber 33 is input with AC power AC provided from the first socket 11 and AC power AC provided from the second socket 12 to be provided through the power wiring unit 25 of the light emitting device illumination part 20.

The AC-DC converter 34 converts the AC power supplied through the first and second sockets 11 and 12 into DC power, and the regulator 35 allows the DC power output from the AC-DC converter 34 to be output as constant DC voltage. For example, as shown in FIG. 5, the AC-DC converter 34 and the regulator 35 may include a bridge rectifier 34a and a smoothing circuit 35a.

As described above, the power supply unit of the adapter 30 receives AC power from the first socket 11 and the second socket 12 to convert it into DC power, thereby providing power.

The light emitting device driver 36 outputs the DC power supplied from the regulator 35 as driving power that is proper in driving the plurality of light emitting devices 21, that is, driving pulse.

For example, as shown in FIG. 6, the light emitting device driver 36 includes a first light emitting device driver 36a, a second light emitting device driver 36b, a third light emitting device driver 36c, and a fourth light emitting device driver 36d, wherein the first light emitting device driver 36a, the second light emitting device driver 36b, the third light emitting device driver 36c, and the fourth light emitting device driver 36d drive a first light emitting device string 21a, a second light emitting device string 21b, a third light emitting device string 21c, and a fourth light emitting device string 21d on the light emitting device unit 26 of the light emitting device illumination part 20, respectively.

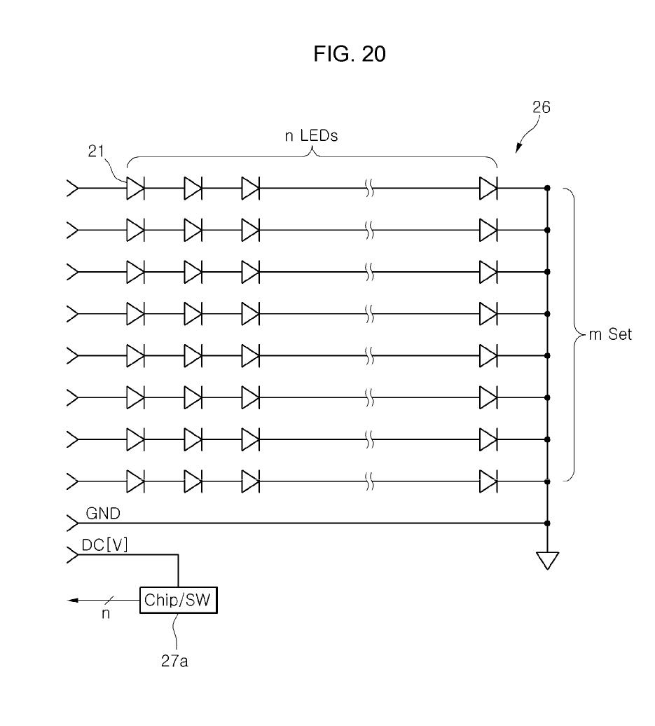

For example, as shown in FIG. 20, the plurality of light emitting devices 21 may be connected to the light emitting device unit 26, wherein as shown in FIG. 6, the plurality of light emitting devices 21 form a plurality of light emitting device strings. For example, m LED strings where n LED are connected in series are shown in FIG. 20.

The light emitting device driver 36 controls the first light emitting device driver 36a, the second light emitting device driver 36b, the third light emitting device driver 36c, and the fourth light emitting device driver 36d to control the length, interval, etc. of the driving pulses of the first light emitting device string 21a, the second light emitting device string 21b, the third light emitting device string 21c, and the fourth light emitting device string 21d, allowing various colors of light to be emitted.

The controller 38 controls the first light emitting device driver 36a, the second light emitting device driver 36b, the third light emitting device driver 36c, and the fourth light emitting device driver 36d to drive the first light emitting device string 21a, the second light emitting device string 21b, the third light emitting device string 21c, and the fourth light emitting device string 21d.

Meanwhile, the lamp information generator 27 is on the light emitting device illumination part 20.

The lamp information generator 27 provides lamp information on the light emitting device illumination part 20 to the controller 38 of the adapter 30. The lamp information generator 27 can provide lamp information to the controller 38 using an electrical/mechanical method, and, for example, a chip 27a provided with software SW including the lamp information on the light emitting device illumination part 20 is shown in FIG. 7.

The lamp information on the light emitting device illumination part 20 may include, for example, information on the size of the substrate 23, information on the sort and the number of the light emitting devices 21 installed on the substrate 23, information on the brightness and the color of light emitted from the light emitting device illumination part 20, and/or information on the power including voltage and current to drive the light emitting device illumination part 20.

When the lamp information generator 27 is provided in the chip 27a shape as shown in FIG. 20, the lamp information generator 27 receives voltage DC from the adapter 30 to provide the lamp information to the controller 38 of the adapter 30.

The controller 38 receives the lamp information, making it possible to adaptively drive the light emitting device illumination part 20 according to the lamp information. For example, the controller 38 can allow proper voltage and current to be provided to the light emitting device illumination part 20 according to the power information of the lamp information.

Moreover, for example, the controller 38 can provide a proper driving signal so that desire brightness and color can be emitted from the light emitting device illumination part 20 according to the information on the brightness and color of the light emitted from the light emitting device illumination part 20.

The communication 39 performs communication with the remote controller 50 and the controller 38 may also be remotely controlled by the remote controller 50. The communication unit 39 and the remote controller 50 can perform communication in a wireless communication method, for example, according to Zigbee standard.

The remote controller 50 includes a network interface 51 that transmits data to the communication unit 39, a key input unit 54 into which a user operation command is input, a display unit 52 that displays a user operation state, and a control unit 53 that controls the network interface 51 and the display unit 52 according to the signal of the key input unit 54.

Therefore, as the user transmits the control command to the communication unit 39 using the remote controller 50, the communication unit 39 transmits the user control command to the controller 38, making it possible to control the light emitting device illumination part 20.

For example, the user can control the light emitting device illumination part 20 to emit a specific color of light using the remote controller 50, and the controller 38 can control the first light emitting device driver 36a, the second light emitting device driver 36b, the third light emitting device driver 36c, and the fourth light emitting device driver 36d to be selectively driven according to the signal input from the communication unit 39.

Moreover, the user can allow the light emitting device illumination part 20 to be turned on or turned off after a predetermined time elapses, using the remote controller 50. In other words, by inputting a timer function, the user can allow the controller 38 to control the light emitting device driver 36 according to the change of time.

The function block 60 is coupled detachably to the function block slot 30a of the adapter 30, making it possible to be connected to the controller 38.

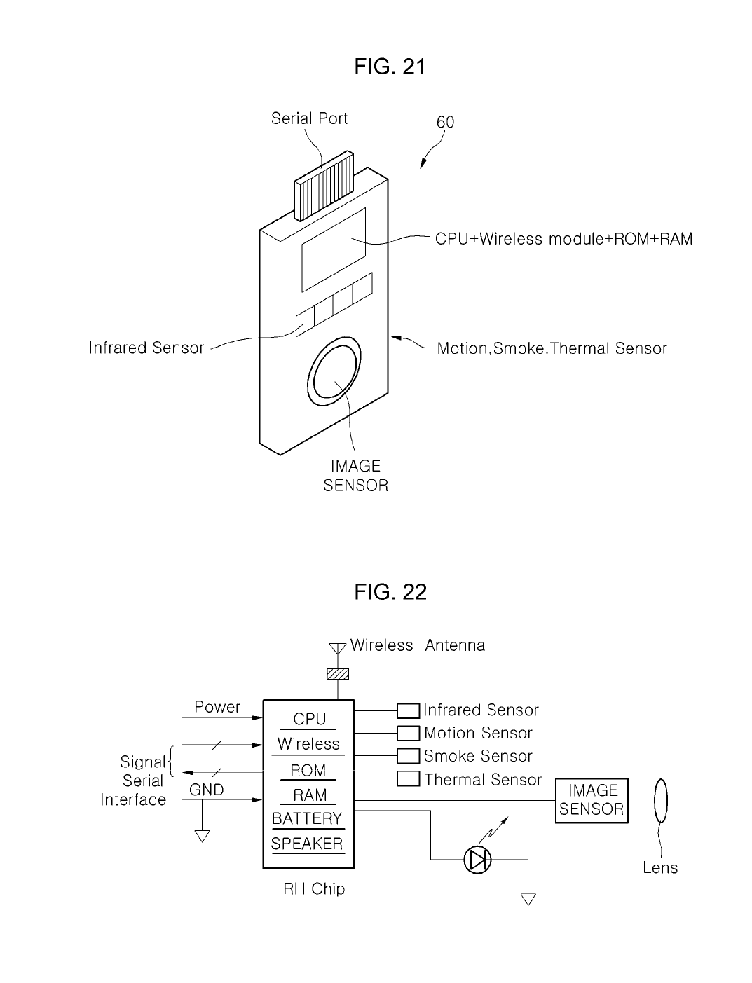

FIG. 21 is a diagram showing the function block in the illumination apparatus according to the fourth embodiment.

Referring to FIG. 21, the function block 60 includes a serial port that can be inserted into the function block slot 30a, wherein, for example, the serial port may be a USB connector. The interface and communication methods between the function block slot 30a and the function block 60 may be diversely selected.

And, the function block 60 includes at least one of an infrared sensor, an image sensor, a smoke sensor, a motion sensor, and a thermal sensor, making it possible to perform one or more of an intruder sensing function, a monitoring camera function, and a fire sensing function.

For example, the infrared sensor, the motion sensor, and the thermal sensor can be used for performing the intruder sensing function, the smoke sensor and the thermal sensor can be used for performing the fire sensing function, and the image sensor can be used for performing the monitoring camera function.

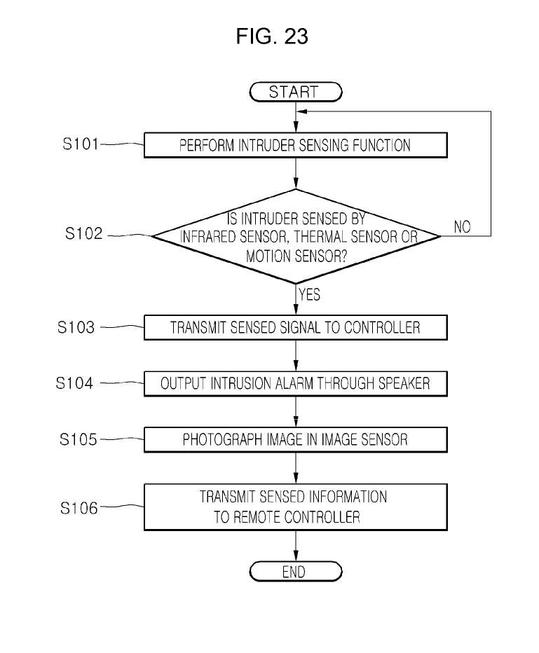

With the flow chart of FIG. 23 in which the intruder sensing function is performed in the illumination apparatus according to the fourth embodiment, if the function block 60 senses the motion of a human through the infrared sensor, the thermal sensor, and the motion sensor (S102), while the intruder sensing function of the function block 60 is operated (S101), it transmits the sensed signal to the controller 38 (S103) and the controller 38 outputs an intrusion alarm through a speaker (S104).

And, the controller 38 can control the image sensor to photograph an image and can transmit the sensed information to the remote controller 50 through the communication unit 39. At this time, the function block 60 can transmit the image obtained through the image sensor to the controller 38, and the controller 38 can transmit the image to the remote controller 50 through the communication unit 39.

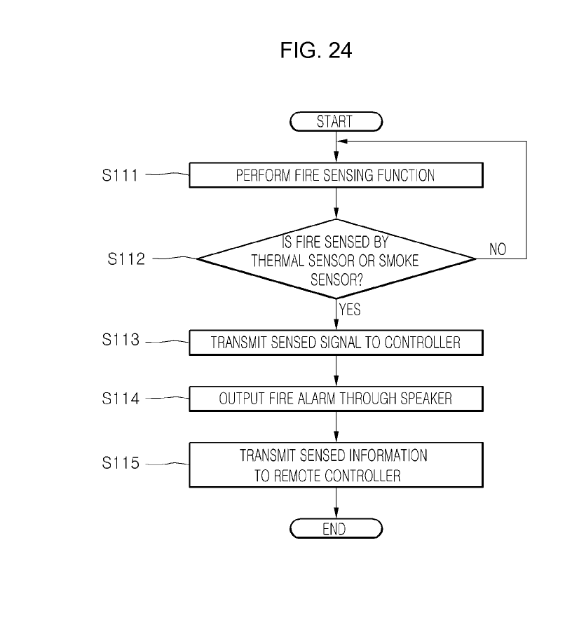

With the flow chart of FIG. 24 in which the fire sensing function is performed in the illumination apparatus according to the fourth embodiment, if the function block 60 senses fire through the thermal sensor or the smoke sensor (S112), while the fire sensing function of the function block 60 is operated (S111), it transmits the sensing signal to the controller 38 (S113) and the controller 38 outputs an fire alarm through a speaker (S114).

And, the controller 38 can transmit the sensed information to the remote controller 50 through the communication unit 39.

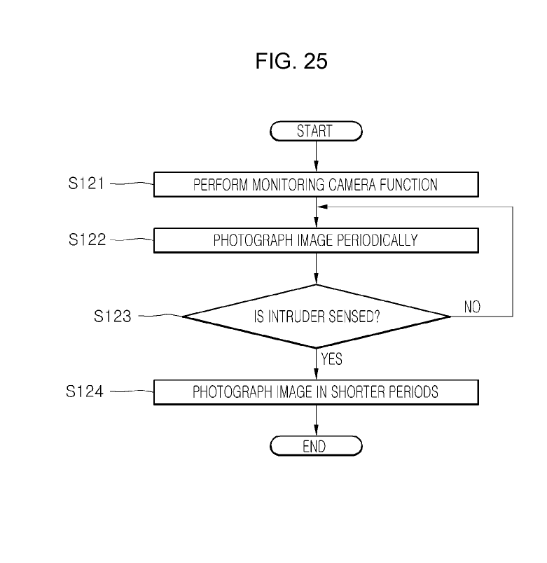

With the flow chart of FIG. 25 in which the monitoring camera function is performed in the illumination apparatus according to the fourth embodiment, the function block 60 periodically photographs an image through the image sensor (S123), while the monitoring camera function of the function block 60 is operated (S121). When an intruder is sensed as described above (S123), the function block 60 can photograph an image in shorter periods (S124).

The user can, of course, perform various controls including the turn-on/turn-off of the operation of the function block 60 through the remote controller 50.

Moreover, the function block 60 may also include CPU for control, wireless module for communication, and ROM and RAM for programming and memory.

FIG. 22 is a diagram showing a functional viewpoint of the function block in the illumination apparatus according to the fourth embodiment.

In the illumination apparatus according to the fourth embodiment, constituents provided in the adapter 30 may be provided in the function block 60. For example, the light emitting device driver 36, the controller 38, and the communication unit 39 provided in the adapter 30 may be provided in the function block 60 other than the adapter 30 and may also be provided in both the adapter 30 and the function block 60.

The function block 60 receives power from the adapter 30 and transmit/receive the signal through a serial interface such as the serial port. Also, the function block 60 may be provided with CPU, ROM, RAM, etc. and may also be provided with wireless module. Also, the function block 60 may be provided with a battery and may be installed with a speaker.

As described above, the illumination apparatus according to the fourth embodiment can also be used in the power supply apparatus for the conventional fluorescent lamp to which AC power is provided, by the adapter 30 including the surge voltage absorber 33, the AC-DC converter 34, the regulator 35, and the light emitting device driver 36.

The illumination apparatus according to the fourth embodiment can obtain the lamp information of the light emitting device illumination part 20 from the adapter 30, making it possible to adaptively control the light emitting device illumination part 20 according to the characteristics of the light emitting device illumination part 20 coupled to the adapter 30.

Moreover, the illumination apparatus according to the fourth embodiment can be controlled remotely by the adapter 30 including the communication unit 39 that performs communication with the remote controller 50.

In addition, the illumination apparatus according to the fourth embodiment has the function block slot 30a and the function block 60 that is detachable to the function block slot 30a, making it possible to perform the intruder sensing function, the monitoring camera function, and the fire sensing function together with the illumination function.

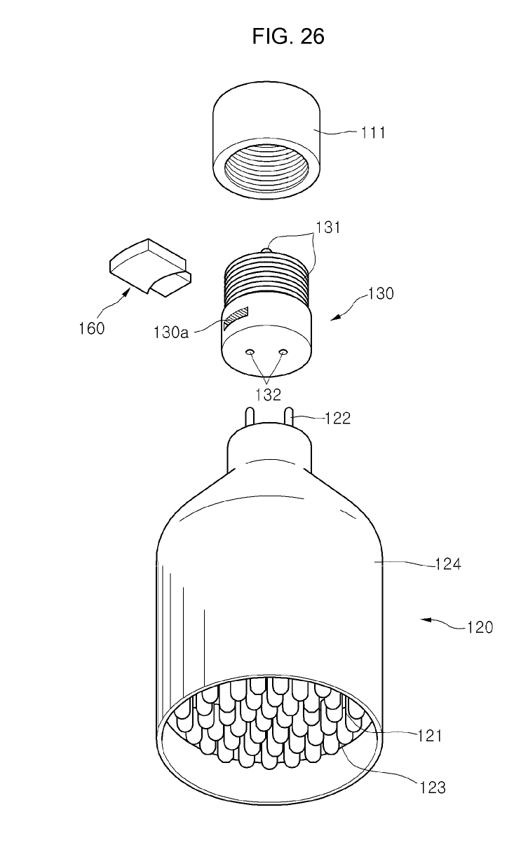

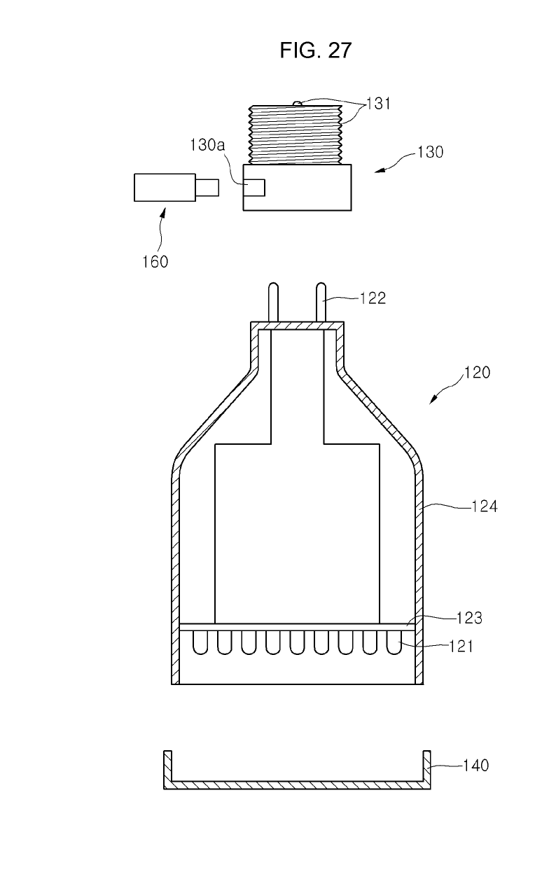

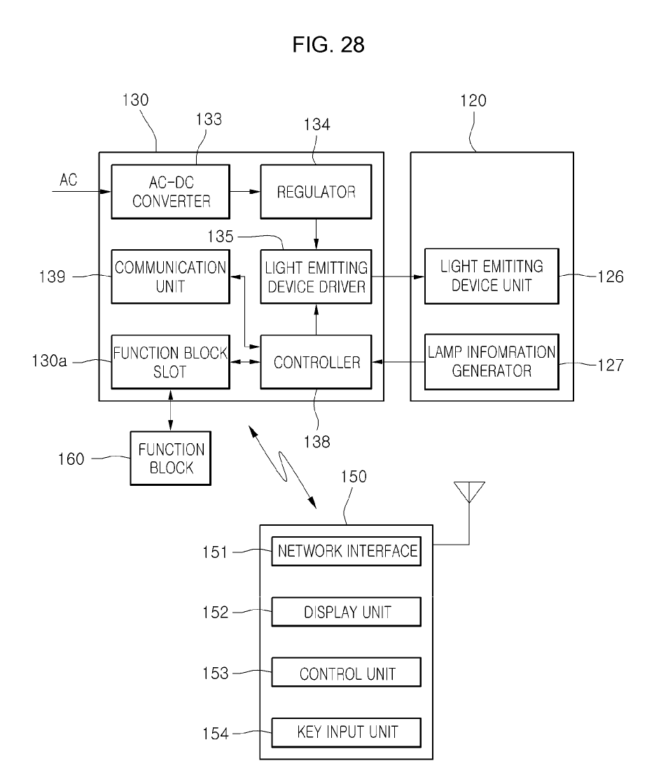

FIG. 26 is a diagram explaining an illumination apparatus according to a fifth embodiment, FIG. 27 is a cross-sectional view of the illumination apparatus according to the fifth embodiment, and FIG. 28 is a block diagram explaining the constitution of the illumination apparatus according to the fifth embodiment.

The illumination apparatus according to the fifth embodiment describes an example where it can be installed at an incandescent lamp socket or a halogen lamp socket so that when explaining the illumination apparatus according to the fifth embodiment, the explanation overlapping with the explanation of the fourth embodiment will be omitted.

Referring to FIGS. 26 and 27, the illumination apparatus according to the fifth embodiment includes an adapter 130 that can be coupled to a socket 111 at which an incandescent lamp or a halogen lamp can be installed and a light emitting device illumination part 120 that is coupled detachably to the adapter 30.

The adapter 130 has a power terminal 131 having a shape that can be coupled to the socket 111, having a spiral projection, and connected electrically to the socket 111, and a connector groove or socket 132 to which the light emitting device illumination part 120 is coupled to be electrically connected.

The light emitting device illumination part 120 includes a connector 122 inserted into the connector groove or socket 132 to be electrically connected, a housing 124 at which the connector 122 is installed, a substrate 123 coupled to the housing 124, and a plurality of light emitting devices 121 installed on the substrate 123. The light emitting device illumination part 120 may further include a cover 140 coupled to the housing 124 in order to protect the plurality of light emitting devices 121.

The substrate 123 may be a printed circuit board (PCB) on which a circuit pattern for providing power to the light emitting devices 121 is formed. Also, the substrate 123 may be a substrate that a wiring for providing power to the light emitting devices 121 is installed on a plastic instrument. The substrate 123 is connected electrically to the connector 122.

Moreover, a reflective coating layer (not shown) maybe formed on the surface of the substrate 123, making it possible to increase efficiency of light emitted from the light emitting devices 121 by coating it with silver (Ag) or aluminum (Al).

In the fifth embodiment, the substrate 123 has a plate shape to be inserted into the inside of the housing 124. Therefore, when the cover 140 is coupled to the housing 124, the substrate 123 and the light emitting devices 121 installed on the substrate 123 are surrounded by the housing 124 and the cover 140.

The light emitting devices 121 may comprise plurality of LED or OLED. For example, the light emitting devices 121 may include LED or OLED that emit red, blue, and green, and white light.

The cover 140 may comprise transparent plastic material, and may also comprise plastic with various colors such as red, green, blue, etc., according to designs. Also, the cover 140 may comprise translucent material and in this case, it may also provide an illumination with a soft atmosphere.

As the light emitting device illumination part 120 is coupled to the adapter 130, the illumination apparatus according to the fifth embodiment can be installed at the socket 111 at which the conventional incandescent lamp or the halogen lamp are installed.

Moreover, as the adapter 130 converts AC power applied to the conventional incandescent lamp or halogen lamp into DC power, the illumination apparatus according to the fifth embodiment allows the light emitting devices 121 to be driven.

Therefore, although a power supply apparatus including the socket 111 where the conventional incandescent lamp or halogen lamp is installed is not replaced, an illumination apparatus using LED or OLED can be used.

In particular, since the light emitting device illumination part 120 and the adapter 130 are detachably installed, when defects are generated on the light emitting device illumination part 120 or the adapter 130, only the light emitting device illumination part 120 or the adapter 130 where the defects are generated can be replaced, having low maintenance costs.

Moreover, in the illumination apparatus according to the fifth embodiment, since the light emitting device illumination part 120 and the adapter 130 are detachably installed, illuminations with various atmospheres can be provided by replacing only the light emitting device illumination part 120.

Furthermore, in the illumination apparatus according to the fifth embodiment, the adapter 130 can recognize the sort of the light emitting device illumination part 120 so that the adapter 130 is provided to adaptively control the light emitting device illumination part 120. Therefore, various models of the light emitting device illumination part 120 produced in various manufacturing companies can be freely selected and used.

Referring to FIG. 28, the adapter 130 includes an AC-DC convert 134, a regulator 135, a light emitting device driver 136, a controller 138, a communication unit 139, and a function block slot 130a, wherein the light emitting device illumination part 120 may include a light emitting device unit 126 and a lamp information generator 127.

More specifically, a function block 160 may be inserted into the function block slot 130a of the adapter 130. The function block 106 is the same as the function block 60 of FIGS. 21 to 25.

The power supply unit that provides power in the adapter 130 includes the AC-DC converter 134 and the regulator 135.

The AC-DC converter 134 converts the AC power supplied through the socket 111 into DC power, and the regulator 135 allows the DC power output from the AC-DC converter 134 to be output as constant DC voltage. For example, as shown in FIG. 5, the AC-DC converter 134 and the regulator 135 may include a bridge rectifier 34a and a smoothing circuit 35a.

The light emitting device driver 136 outputs the DC power supplied from the regulator 135 as driving power that is proper in driving the plurality of light emitting devices 121, that is, driving pulse.

As shown in FIG. 6, the light emitting device driver 136 includes a first light emitting device driver, a second light emitting device driver, a third light emitting device driver, and a fourth light emitting device driver, wherein the first light emitting device driver, the second light emitting device driver, the third light emitting device driver, and the fourth light emitting device driver drive a first light emitting device string, a second light emitting device string, a third light emitting device string, and a fourth light emitting device string on the light emitting device illumination part 120, respectively.

The operation of the light emitting device driver 136 is the same as that of the light emitting device driver 36 of the first embodiment so that the overlapping explanation will be omitted.

The controller 138 controls the first light emitting device driver, the second light emitting device driver, the third light emitting device driver, and the fourth light emitting device driver to drive the first light emitting device string, the second light emitting device string, the third light emitting device string, and the fourth light emitting device string.

For example, the controller 138 provides different driving pulse information to the first light emitting device driver, the second light emitting device driver, the third light emitting device driver, and the fourth light emitting device driver, making it possible to control the color, brightness, chroma, blinking, etc. of light emitted from the plurality of light emitting devices 121.

Meanwhile, a lamp information generator 127 is on the light emitting device illumination part 120.

The lamp information generator 127 provides lamp information on the light emitting device illumination part 120 to the controller 138 of the adapter 310. The lamp information generator 127 can provide lamp information to the controller 138 using an electrical/mechanical method, and, for example, it may also be have a chip 27a shape, as shown in FIG. 20.

The lamp information on the light emitting device illumination part 120 may include, for example, information on the size of the substrate 123, information on the sort and the number of the light emitting devices 121 installed on the substrate 123, information on the brightness and the color of light emitted from the light emitting device illumination part 120, and/or information on the power including proper voltage and current in driving the light emitting device illumination part 120.

The lamp information generator 127 receives voltage DC from the adapter 30 to provide the lamp information to the controller 138 of the adapter 130. The controller 138 receives the lamp information, making it possible to adaptively drive the light emitting device illumination part 120 according to the lamp information.

For example, the controller 138 can allow proper voltage and current to be provided to the light emitting device illumination part 120 according to the power information of the lamp information.

Moreover, for example, the controller 138 can provide a proper driving signal so that desire brightness and color can be emitted from the light emitting device illumination part 120 according to the information on the brightness and color of the light emitted from the light emitting device illumination part 120.

The communication 139 performs communication with the remote controller 150 and the controller 138 may also be remotely controlled by the remote controller 150. The communication unit 139 and the remote controller 150 can perform communication in a wireless communication method, for example, according to Zigbee standard.

The remote controller 150 includes a network interface 151 that transmits data to the communication unit 139, a key input unit 514 into which a user operation command is input, a display unit 152 that displays a user operation state, and a control unit 153 that controls the network interface 151 and the display unit 152 according to the signal of the key input unit 154.

Therefore, as the user transmits the control command to the communication unit 139 using the remote controller 150, the communication unit 139 transmits the user control command to the controller 138, making it possible to control the light emitting device illumination part 120.

The function block 160 is coupled detachably to the function block slot 130a of the adapter 130, making it possible to be connected to the controller 138. The function block 160 includes at least one of an infrared sensor, an image sensor, a smoke sensor, a motion sensor, and a thermal sensor, making it possible to perform one or more of an intruder sensing function, a monitoring camera function, and a fire sensing function.

As described above, the illumination apparatus according to the fifth embodiment can also be used in the power supply apparatus for the conventional incandescent lamp or halogen lamp to which AC power is supplied, by the adapter 130 including the AC-DC convert 134, the regulator 135, and the light emitting device driver 136.

Moreover, the illumination apparatus according to the fifth embodiment can obtain the lamp information of the light emitting device illumination part 120 from the adapter 130, making it possible to adaptively control the light emitting device illumination part 120 according to the characteristics of the light emitting device illumination part 120 coupled to the adapter 130.

Furthermore, the illumination apparatus according to the fifth embodiment can be controlled remotely by the adapter 130 including the communication unit 139 that performs communication with the remote controller 150.

In addition, the illumination apparatus according to the fifth embodiment has the function block slot 130a and the function block 160 that is detachable to the function block slot 130a, making it possible to perform the intruder sensing function, the monitoring camera function, and the fire sensing function together with the illumination function.

Embodiments of the invention can provide the illumination apparatus using an LED or OLED.

Embodiments can provide the illumination apparatus using the LED or the OLED that can be used without replacing the conventional power supply apparatus installed for the fluorescent lamp.

Embodiments can provide the illumination apparatus that can compatibly use various light emitting device illumination parts by detachably installing the adapter and the light emitting device illumination part.

Embodiments can provide the illumination apparatus that can control the color, brightness, chroma, blinking, etc. of light emitted from the light emitting device illumination part.

Embodiments can provide the illumination apparatus that emits various colors of light by controlling the plurality of light emitting devices that emit red, green, blue, and white light.

Embodiments can provide the illumination apparatus that can be remotely controlled.

Embodiments can provide the illumination apparatus that can perform the infrared sensing function, the monitoring camera function, and the fire sensing function, and the driving method of the function block in the illumination apparatus.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An illumination apparatus comprising:
an adapter that converts alternating power into driving power;
a communication unit connected to the adapter and configured to communicate with a remote controller;
a controller connected to the communication unit and configured to generate a control signal according to a control command from the communication unit; and
a light emitting device illumination part configured to be connected detachably and electrically to the adapter and comprising a plurality of light emitting devices that emit light according to driving power and the control signal from the controller.

2. The illumination apparatus according to claim 1, wherein the adapter includes:
an AC-DC converter that converts an AC voltage into a DC voltage;
a regulator that receives the DC voltage from the AC-DC converter and outputs a constant DC voltage; and
a light emitting device driver that outputs the constant DC voltage from the regulator as one or more driving pulses.

3. The illumination apparatus according to claim 2, wherein the adapter further includes a surge voltage absorber that absorbs a surge voltage.

4. The illumination apparatus according to claim 1, wherein the adapter includes a memory storing driving pulse information regarding the driving pulse(s) applied to the plurality of light emitting devices, and the controller extracts the driving pulse information from the memory to control the plurality of light emitting devices.

5. The illumination apparatus according to claim 1, wherein the light emitting device illumination part includes a red light emitting device string, a green light emitting device string, a blue light emitting device string, and a white light emitting device string, and the adapter includes a plurality of light emitting device drivers that control the red light emitting device string, the green light emitting device string, the blue light emitting device string, and the white light emitting device string.

6. The illumination apparatus according to claim 1, wherein the light emitting devices comprise LEDs or OLEDs.

7. An illumination apparatus comprising:
an adapter that converts commercial power to driving power; and
a LED illumination part configured to be coupled detachably to the adapter, comprising a plurality of LEDs that emit light according to the driving power from the adapter,
wherein the adapter includes a function block comprising at least one of an infrared sensor, an image sensor, and a fire sensor; a communication unit configured to communicate with a remote controller; and a controller connected to the function block and the communication unit, configured to control the function block and the LED illumination part according to control command(s) from the communication unit.

8. The illumination apparatus according to claim 7, wherein the adapter includes an AC-DC converter that converts an AC voltage into a DC voltage, a regulator that receives the DC voltage from the AC-DC converter and outputs a constant DC voltage;
and a LED driver that outputs the constant DC voltage from the regulator as one or more driving pulses.

9. The illumination apparatus according to claim 8, wherein the adapter further includes a surge voltage absorber that absorbs a surge voltage.

10. The illumination apparatus according to claim 7, wherein the adapter includes a memory storing driving pulse information regarding the driving pulse(s) applied to the plurality of LEDs, and the controller extracts the driving pulse information from the memory to control the plurality of LEDs.

11. The illumination apparatus according to claim 1, wherein the LED illumination part includes a red LED string, a green LED string, a blue LED string, and a white LED string, and the adapter includes a plurality of LED drivers that control the red LED string, the green LED string, the blue LED string, and the white LED string.

12. An illumination apparatus comprising:
an adapter configured to be coupled detachably and electrically to an illumination apparatus socket;
a power supply unit in the adapter, configured to supply power;
a light emitting device driver in the adapter, configured to generate driving power using the power from the power supply unit;
a light emitting device illumination part configured to be connected to the adapter and comprising a plurality of light emitting devices driven by the driving power from the light emitting device driver;
a function block connected to the adapter and including at least one of an infrared sensor, an image sensor, a motion sensor, and a thermal sensor; and
a controller that controls the light emitting device driver and the function block.

13. The illumination apparatus according to claim 12, wherein a function block slot is in the adapter and the function block is configured to be coupled detachably to the function block slot.

14. The illumination apparatus according to claim 12, wherein the light emitting devices comprise LEDs or OLEDs.

15. The illumination apparatus according to claim 12, wherein the infrared sensor, the motion sensor, and the thermal sensor perform an intruder sensing function.

16. The illumination apparatus according to claim 12, wherein the smoke sensor and the thermal sensor perform a fire sensing function.

17. The illumination apparatus according to claim 12, wherein the image sensor performs a monitoring camera function.

18. The illumination apparatus according to claim 12, comprising:
a communication unit connected to the controller, configured to communicate with a remote controller.

19. The illumination apparatus according to claim 18, wherein the communication unit is in the adapter.

20. The illumination apparatus according to claim 18, wherein the communication unit is in the function block.

21. A method of driving an illumination apparatus, comprising:
converting applied power to driving power in an adapter;
transmitting one or more user control commands from a remote controller to a communication unit connected to the adapter;
generating a control signal in a controller connected to the communication unit according to the control command; and
emitting light from a light emitting display illumination part according to the driving power and the control signal.

22. The method according to claim 21, further comprising controlling a plurality of light emitting display strings of the light emitting display illumination part with a plurality of light emitting display drivers connected to the adapter.

23. A method of driving a function block in an illumination apparatus, comprising:
sensing motion using an infrared sensor, a thermal sensor, or a motion sensor;
transmitting a signal corresponding to the sensed motion to a controller;
outputting an activation signal to an alarm from the controller; and
photographing an image using an image sensor receiving a command from the controller.

24. The method according to claim 23, further comprising:
transmitting the photographed image to a remote controller.

25. The method according to claim 23, further comprising emitting light from a light emitting display illumination part of the illumination apparatus before photographing the image.

26. A method of driving a function block in an illumination apparatus, comprising:
sensing heat or fire using a smoke sensor or a thermal sensor;
transmitting a signal corresponding to the sensed heat or fire to a controller; and
outputting an activation signal to an alarm from the controller.

27. The method according to claim 26, further comprising:
transmitting the signal corresponding to the sensed heat or fire to a remote controller.

28. The method according to claim 26, further comprising emitting light from a light emitting display illumination part of the illumination apparatus.

29. A method of driving a function block in an illumination apparatus, comprising:
periodically photographing an image using an image sensor; and
periodically photographing the image more frequently as motion is sensed through an infrared sensor, a thermal sensor, or a motion sensor in electrical communication with a controller, the controller being in electrical communication with the image sensor.

30. The method according to claim 29, further comprising emitting light from a light emitting display illumination part of the illumination apparatus before periodically photographing the image.
